(19) United States
(12) Patent Application Publication
(10) Pub. No.: US 2024/0035663 A1
(43) Pub. Date: Feb. 1, 2024

(54) STOVE

(71) Applicant: Liling Yang, Dongguan (CN)

(72) Inventor: Liling Yang, Dongguan (CN)

(21) Appl. No.: 18/377,917

(22) Filed: Oct. 9, 2023

(30) Foreign Application Priority Data
Sep. 22, 2023 (CN) 202322599032.5

(51) Int. Cl. F24B 5/02

(52) U.S. Cl. CPC F24B 5/023

(57) ABSTRACT

The present disclosure provides a stove includes an adjustment member, an outer barrel and an inner barrel arranged inside the outer barrel. The inner barrel is spaced apart from the outer barrel and forms a middle cavity with the outer barrel; a first air inlet hole communicated with the middle cavity is formed in a side wall of the outer barrel, and a second air inlet hole communicated with the middle cavity is formed in a side wall of the inner barrel; and the adjustment member is configured to adjust a size of the first air inlet hole under the action of an external force, and/or to adjust a size of the second air inlet hole. Thus, air entering the inner barrel can be adjusted to achieve an effect of adjusting a size of firewood.

### CROSS-REFERENCE TO RELATED APPLICATIONS

The application claims priority of Chinese patent application CN2023225990325, filed on Sep. 22, 2023, which is incorporated herein by reference in its entireties.

### TECHNICAL FIELD

The present disclosure relates to the technical field of outdoor appliances, and in particular, to a stove.

### BACKGROUND

As is well known, a firewood stove is a stove that burns firewood, which is generally composed of an inner barrel and an outer barrel. Air inlet holes are formed in a bottom of the outer barrel and a position, close to a top, of the inner barrel. During burning of firewood, air enters the stove via the air inlet holes, so as to facilitate the burning of the firewood.

However, a size of an existing air inlet hole is fixed at present. As a result, a size of firewood inside cannot be controlled, which cannot meet a demand of a user for controlling the size of the firewood.

### SUMMARY

The present disclosure mainly aims to provide a stove to solve the problem that a size of firewood cannot be controlled in an existing firewood stove.

In order to solve the technical problem, the technical scheme provided by the present disclosure is as follows.

A stove includes an adjustment member, an outer barrel and an inner barrel arranged inside the outer barrel. The inner barrel is spaced apart from the outer barrel and forms a middle cavity with the outer barrel; a first air inlet hole communicated with the middle cavity is formed in a side wall of the outer barrel, and a second air inlet hole communicated with the middle cavity is formed in a side wall of the inner barrel; and the adjustment member is configured to adjust a size of the first air inlet hole under the action of an external force, and/or to adjust a size of the second air inlet hole.

Preferably, the adjustment member includes a baffle plate movably arranged at a position, located at the first air inlet hole, on the outer barrel, and a poke rod arranged on the baffle plate; and the baffle plate moves when the poke rod is pushed by the external force to gradually cover or move away from the first air inlet hole.

Preferably, a quantity of the first air inlet hole is plural, and the baffle plate is provided with a plurality of third air inlet holes having a same size as that of each first air inlet hole.

Preferably, a distance between two adjacent first air inlet holes is greater than a length of each first air inlet hole.

Preferably, cross sections of both the outer barrel and the inner barrel are circular; the baffle plate is ringlike and located in the middle cavity; and one end of the poke rod is connected to the baffle plate after passing through the first air inlet hole.

Preferably, the baffle plate is provided with a first screw hole located between two adjacent third air inlet holes; one end of the poke rod is a first screw; and the poke rod is mounted on the baffle plate through cooperation between the first screw and the first screw holes.

Preferably, a fourth air inlet hole is formed in the side wall of the inner barrel, and the fourth air inlet hole is located between the first air inlet hole and the second air inlet hole.

Preferably, the fourth air inlet hole is a mesh hole; a top of the mesh hole is close to the first air inlet hole; and a bottom of the mesh hole is close to the second air inlet hole.

Preferably, a viewing window is arranged on the outer barrel; a transparent piece is arranged at the viewing window; and the viewing window corresponds to the fourth air inlet hole.

Preferably, a bottom of the outer barrel is provided with a supporting leg configured to support the stove.

Preferably, the supporting leg is integrally formed with the outer barrel.

Preferably, an inner side wall of the outer barrel is provided with a bottom plate located below the first air inlet hole, and a bottom surface of the baffle plate is in contact with an upper surface of the bottom plate.

Preferably, a bearing slot is formed at a position, close to a top, on the inner side wall of the outer barrel; a top of the inner barrel is connected with a top barrel body; the top barrel body is formed by protruding outwards from the inner barrel; the top barrel body is arranged in the bearing slot to separate a bottom surface of the inner barrel from the bottom plate of the outer barrel; and the second air inlet is located below the top barrel body.

Preferably, a middle portion of a bottom of the inner barrel is raised upwards to form a boss, and a plurality of fifth air inlet holes are formed in a side wall of the boss.

Preferably, the first air inlet hole is located between the bottom surface of the inner barrel and the bottom plate.

Preferably, the outer barrel includes a first barrel body and a second barrel body; the second barrel body is located on an inner side of the first barrel body and abuts against the first barrel body; the first air inlet hole is located on the first barrel body, and the middle cavity is formed by encircling the second barrel body, the baffle plate, the bottom plate, the inner barrel, and the top barrel body; both the first barrel body and the second barrel body are provided with viewing windows; the second barrel body is located above the baffle plate; the bearing slot is formed by cooperation between the first barrel body and the second barrel body; an annular bearing plate is arranged at a position, close to a bottom, on an inner side wall of the second barre body; and the bottom plate is arranged on the annular bearing plate.

Preferably, the stove further includes handle portions arranged on two sides of the outer barrel.

Preferably, the handle portions are T-shaped in a top view.

Preferably, the handle portions are detachably arranged on the outer barrel.

Preferably, a second screw hole is formed in the outer barrel; one end of each handle portion is a second screw; and the handle portions are fixed to the outer barrel through cooperation between second screw and the second screw hole.

Compared with the prior art, the present disclosure has the beneficial effects below: the adjustment member is arranged at the first air inlet hole or the second air inlet hole, so that a size of the first air inlet hole or the second air inlet hole can be adjusted through the adjustment member, that is, air entering the inner barrel can be adjusted to achieve an effect of adjusting a size of firewood.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

FIG. 1 is a three-dimensional diagram of the present disclosure without handle portions;

FIG. 2 is an exploded diagram of the present disclosure;

FIG. 3 is a sectional view of the present disclosure cut away along a center line of a poke rod;

FIG. 4 is an exploded view of an adjustment member of the present disclosure;

FIG. 5 is a schematic diagram of the present disclosure without a top cover and a first barrel body;

FIG. 6 is a structural diagram of an outer barrel of the present disclosure;

FIG. 7 is a structural diagram of an inner barrel of the present disclosure;

FIG. 8 is a top view of the present disclosure; and

FIG. 9 is a structural diagram of a handle portion of the present disclosure.

### DETAILED DESCRIPTION OF THE EMBODIMENTS

The accompanying drawings in the embodiment of the present disclosure are combined, The technical scheme in the embodiment of the present disclosure is clearly and completely described, Obviously, the described embodiment is only a part of the embodiment of the present disclosure, but not all embodiments are based on the embodiment of the present disclosure, and all other embodiments obtained by ordinary technicians in the field on the premise of not doing creative work belong to the protection range of the present disclosure.

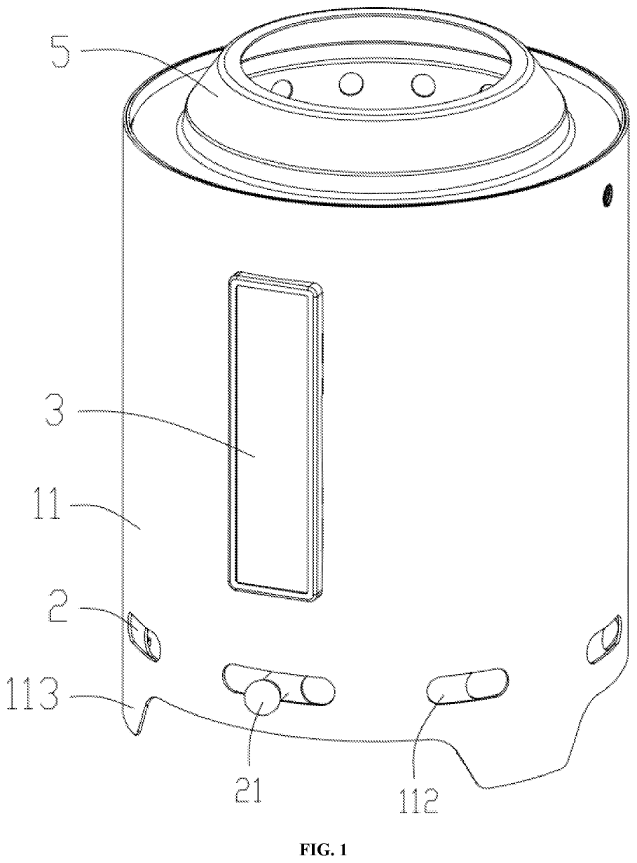

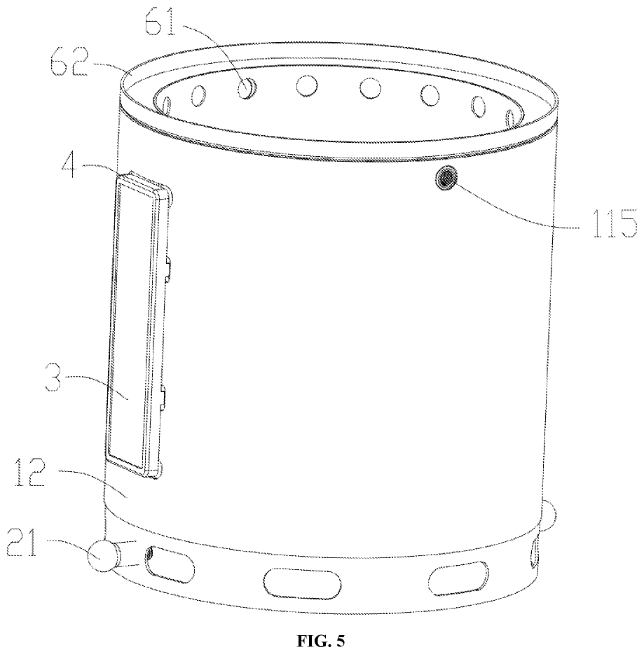

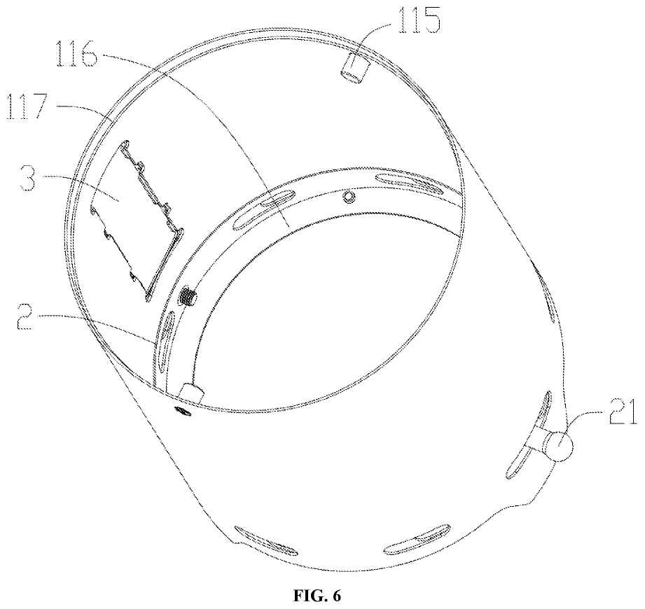

Referring to FIG. 1 to FIG. 9, an embodiment of the present disclosure provides a stove.

Referring to FIG. 1 to FIG. 3, a stove includes an adjustment member 2, an outer barrel 1, and an inner barrel 6 arranged in the outer barrel 1. The inner barrel 6 is spaced apart from the outer barrel 1 and forms a middle cavity 8 with the outer barrel 1. A first air inlet hole 112 communicated with the middle cavity 8 is formed in a side wall of the outer barrel 1, and a second air inlet hole 61 communicated with the middle cavity 8 is formed in a side wall of the inner barrel 6. The adjustment member 2 is configured to adjust a size of the first air inlet hole 112 under the action of an external force, and/or to adjust a size of the second air inlet hole 61.

In this embodiment, the adjustment member 2 is arranged at the first air inlet hole 112 or the second air inlet hole 61, so that a size of the first air inlet hole 112 or the second air inlet hole 61 can be adjusted through the adjustment member 2, that is, air entering the inner barrel 6 can be adjusted to achieve an effect of adjusting a size of firewood.

As is well known, firewood can be burnt more vigorously in a place with sufficient oxygen, while on the contrary, firewood can be less burnt or even extinguished in a place with insufficient oxygen. Therefore, the size of the first air inlet hole 112 or the second air inlet hole 61 is adjusted through the adjustment member 2 to control entry of oxygen, thereby controlling the size of the firewood.

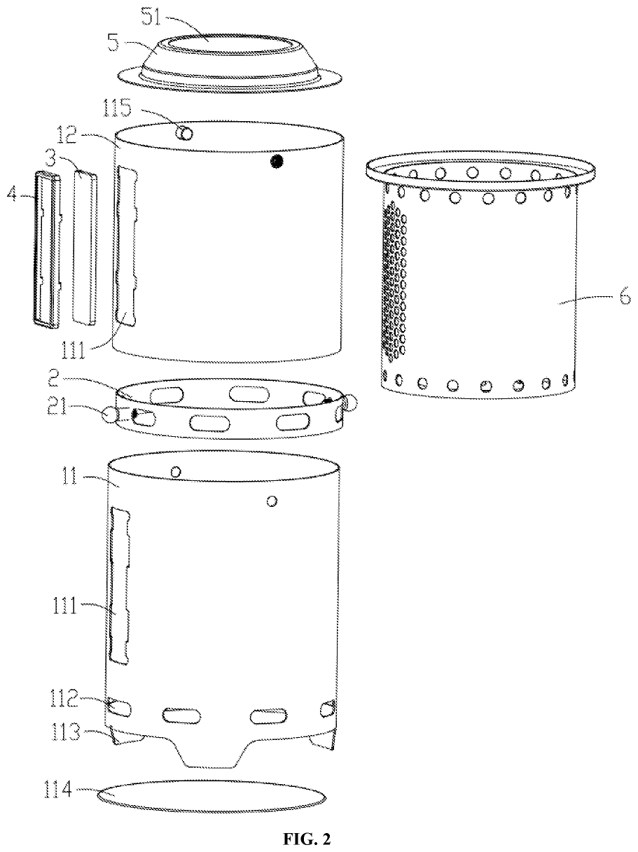

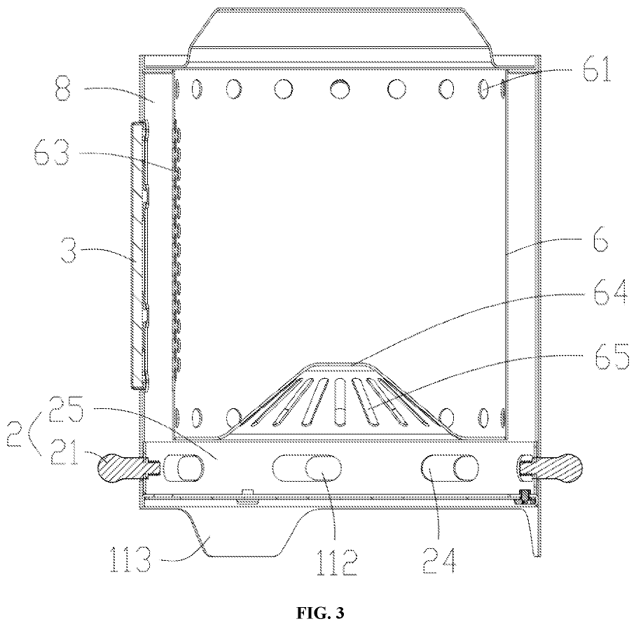

Specifically, referring to FIG. 2 and FIG. 3, in the above embodiment, the adjustment member 2 includes a baffle plate 25 movably arranged at a position, located at the first air inlet hole 112, on the outer barrel 1, and poke rods 21 arranged on the baffle plate 25. Therefore, when the poke rod 21 is pushed, the baffle plate 25 can be pushed in a linked manner. In the moving process, the baffle plate 25 gradually covers the first air inlet hole 112 or moves away from the first air inlet hole 112, so as to control a volume of air. The baffle plate 25 can move up and down, or move in a left-right direction of the first air inlet hole 112, so as to gradually cover the first air inlet hole 112 or gradually move away from the first air inlet hole 112.

When the baffle plate 25 moves in the left-right direction of the first air inlet hole 112, a quantity of the first air inlet hole 112 is plural, and the first air inlet holes are spaced apart from each other. The baffle plate 25 is provided with a plurality of third air inlet holes 24 having a same size as that of each first air inlet hole 112. The quantity of the first air inlet holes 112 is the same as the quantity of the third air inlet holes 24, so that when the baffle plate 25 moves, the third air inlet holes 24 can be opposite to the first air inlet holes 112 to achieve air intake.

A distance between two adjacent first air inlet holes 112 is greater than a length of each first air inlet hole 112, that is, the distance between two adjacent third air inlet holes 24 is greater than a length of each third air inlet hole 24. During rotation of the baffle plate 25, a position between two third air inlet holes 24 of the baffle plate 25 can completely cover the first air inlet hole 112 to prevent entry of air.

Cross sections of both the outer barrel 1 and the inner barrel 6 are circular. The baffle plate 25 is ringlike and located in the middle cavity 8. One end of each poke rod 21 is connected to the baffle plate 25 after passing through the first air inlet hole 112, so that when the poke rod 21 is pushed, the baffle plate 25 can be allowed to rotate along a center shaft of the outer barrel 1. Of course, in other embodiments, the baffle plate 25 is not ringlike, but a quantity of the baffle plate 25 is the same as the quantity of the first air inlet hole 112. A size of each baffle plate 25 is slightly larger than a size of each first air inlet hole 112. When each baffle plate 25 is pushed to move by the poke rods 21, the baffle plate can directly cover the first air inlet hole 112 or open the first air inlet hole 112.

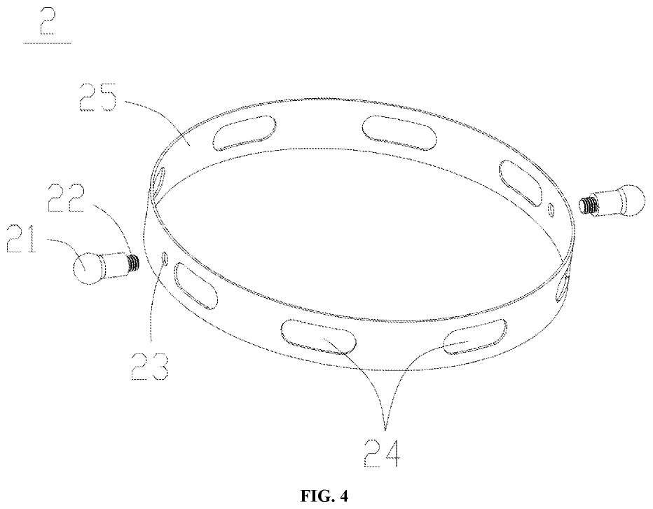

In the above embodiment, referring to FIG. 4, the poke rods 21 are detachably connected to the baffle plate 25. Specifically, the baffle plate 25 is provided with a first screw hole 23 between two adjacent third air inlet holes 24, and one end of each poke rod 21 is a first screw 22. A pulling part is mounted on the baffle plate 25 through cooperation between the first screws 22 and the first screw holes 23. In other embodiments, the poke rods 21 can also be fixed by plugging, or locked onto the baffle plate 25 by bolts or the like.

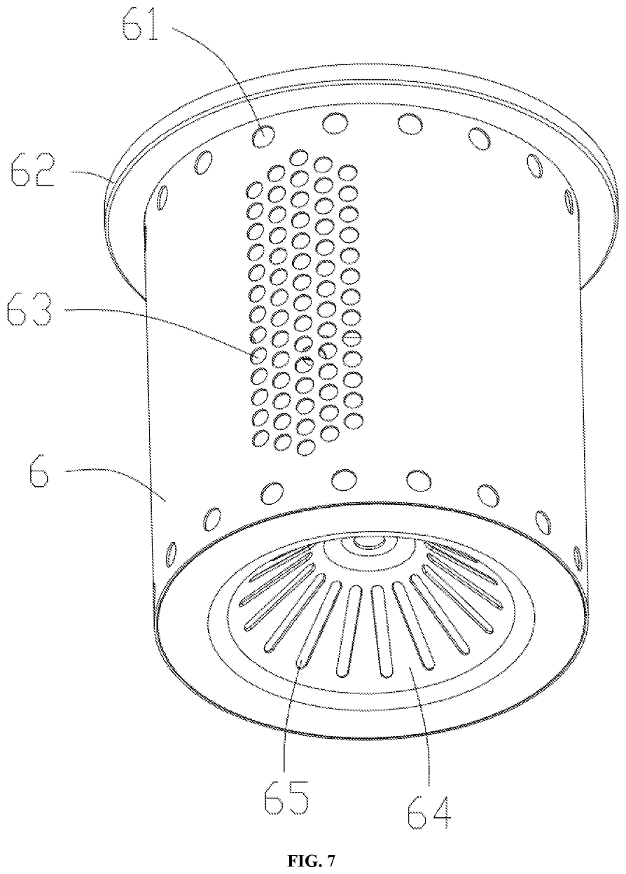

In an embodiment, referring to FIG. 7, fourth air inlet holes 63 are formed in the side wall of the inner barrel 6, and the fourth air inlet holes 63 are located between the first air inlet holes 112 and the second air inlet holes 61. Therefore, air entering from the first air inlet holes 112 can effectively and more quickly enter the inner barrel 6 for firewood combustion. Specifically, the fourth air inlet holes 63 are mesh holes. A top of each mesh hole is close to the first air inlet holes 112; and a bottom of each mesh hole is close to the second air inlet holes 61, so as to achieve a distribution in a larger range and achieve a better effect.

In one embodiment, referring to FIG. 2, a viewing window 111 is arranged on the outer barrel 1. A transparent piece 3 is arranged at the viewing window 111, and the viewing window 111 corresponds to the fourth air inlet holes 63. Therefore, a fire size inside the inner barrel 6 can be observed through the viewing window 111 and the fourth air inlet holes 63, so that a user adjusts the position of the baffle plate 25 through the poke rods 21. to control a size of firewood.

In an embodiment, a bottom of the outer barrel 1 is provided with a supporting leg 113 configured to support the stove. By means of the supporting leg 113, the outer barrel 1 can be suspended, and the bottom of the outer barrel 1 can be prevented from being in direct contact with the ground, which facilitates use. Specifically, there may be three, four, five, or more supporting legs 113. If a supporting leg 113 has an enough wide bottom surface, there are two supporting legs 113. Or, when a supporting leg 113 is ringlike, there can also be one supporting leg 113. A quantity of the supporting leg 113 will not be limited here.

For ease of manufacturing, the supporting legs 113 may be integrally formed with the outer barrel 1. In other embodiments, the supporting leg 113 may also be fixed at the bottom of the outer barrel 1 through bolts or in a welded manner.

In the above embodiment, referring to FIG. 2, an inner side wall of the outer barrel 1 is provided with a bottom plate 114 located below the first air inlet holes 112, and a bottom surface of the baffle plate 25 is in contact with an upper surface of the bottom plate 114. Therefore, the bottom plate 114 can be used to support the baffle plate 25. Specifically, a height of the baffle plate 25 is greater than a distance from the bottom plate 114 to tops of the first air inlet holes 112 to facilitate assembling of the baffle plate 25. Furthermore, when the pulling part is pushed, the baffle plate 25 can move.

A bearing slot 117 is formed at a position, close to a top, on the inner side wall of the outer barrel 1. A top of the inner barrel 6 is connected with a top barrel body 62. The top barrel body 62 is formed by protruding outwards from the inner barrel 6. The top barrel body 62 is arranged in the bearing slot 117 to separate a bottom surface of the inner barrel 6 from the bottom plate 114 of the outer barrel 1. Direct contact between the bottom of the inner barrel 6 and the bottom of the outer barrel 1 is prevented, and a thermal insulation effect is achieved. An outer side wall of the top barrel body 62 abuts against the inner side wall of the outer barrel 1, which can improve the attractiveness of the stove of this embodiment. The second air inlet holes 61 are located below the top barrel body 62 and are communicated with the first air inlet holes 112 through the middle cavity 8.

In an embodiment, a middle portion of a bottom of the inner barrel 6 is raised upwards to form a boss 64. By use of the boss 64, firewood can be erected when a user places the firewood into the inner barrel 6, which facilitates burning of the firewood. A plurality of fifth air inlet holes 65 are formed in a side wall of the boss 64. By the use of the fifth air inlet holes 65, the air entering from the first air inlet holes 112 can more effectively enter the inner barrel 6. Furthermore, during the burning of the firewood, the air entering from the first air inlet holes 112 can be in contact with the firewood in multiple angles, which increases the utilization rate of the air entering from the first air inlet holes 112. Specifically, a cross section of the boss 64 is circular, and a diameter of the circle gradually increases from top to bottom, so as to erect the firewood. Of course, in other embodiments, the boss 64 can also be terraced or irregularly shaped. Or, a quantity of the boss 64 may be plural, which can also erect the firewood.

In an embodiment, the first air inlet holes 112 are located between the bottom surface of the inner barrel 6 and the bottom plate 114, so that it is convenient for the air entering from the first air inlet holes 112 to enter the inner barrel 6 from the fifth air inlet holes 65.

In an embodiment, referring to FIG. 1 to FIG. 3, the stove further includes a top cover 5 arranged on the top barrel body 62. The top cover 5 is provided with a burner port 51. By the use of the top cover 5 and the burner port 51, it is convenient to place a pot body, so that the pot body is heated by the firewood.

In the above embodiment, the outer barrel 1 can be only one barrel body. In other embodiments, referring to FIG. 2 and FIG. 3, the outer barrel 1 may be composed of two barrel bodies, namely, the outer barrel 1 may include a first barrel body 11 and a second barrel body 12. The supporting legs 113 are all located on the first barrel body 11. The second barrel body 12 is located on an inner side of the first barrel body 11 and abuts against the first barrel body 11. Therefore, a bearing slot 117 is formed. The second barrel body 12 is used to support the top barrel body 62 to separate the bottom surface of the inner barrel 6 from the bottom plate 114, which facilitates the mounting of the inner barrel 6. Furthermore, in this state, the top barrel body 62 can also be welded with the first barrel body 11 to improve the connection strength.

The first air inlet holes 112 are located on the first barrel body 11, and the second barrel body 12 are located above the baffle plate 25. By the use of the first barrel body 11, the second barrel body 12, the baffle plate 25, and the top barrel body 62, the strength of the stove of this embodiment can be improved. Of course, the first barrel body 11 and the second barrel body 12 can also be welded, so as to achieve connection between the first barrel body 11 and the second barrel body 12. The middle cavity 8 is formed by encircling the second barrel body 12, the baffle plate 25, the bottom plate 114, the inner barrel 6, and the top barrel body 62. Both the first barrel body 11 and the second barrel body 12 are provided with viewing windows 111.

Specifically, the stove further includes a mounting frame 4. A transparent piece 3 is arranged inside the mounting frame 4. The mounting frame 4 can be fixed to the first barrel body 11 or the second barrel body 12 in a welded manner, or one side, close to the inner barrel 6, of the mounting frame 4 can be bent outwards to form a pressure plate. Therefore, the mounting frame 4 can be arranged inside the first barrel body 11 and located on an outer side of the first barrel body 11 through the viewing window 111 on the first barrel body 11. The pressure plate is arranged between the first barrel body 11 and the second barrel body 12 to achieve fixed mounting, and the second barrel body 12 is used to limit the transparent piece 3 within the mounting frame 4 to facilitate the mounting of the transparent piece 3. The transparent piece 3 can be high-temperature-resistant glass, plastic, or the like. An annular bearing plate 116 is arranged at a position, close to a bottom, on an inner side wall of the second barre body 12, and the bottom plate 114 is arranged on the annular bearing plate 116. Specifically, the bottom plate 114 can be fixed on the annular bearing plate 116 by welding, bolts, or the like.

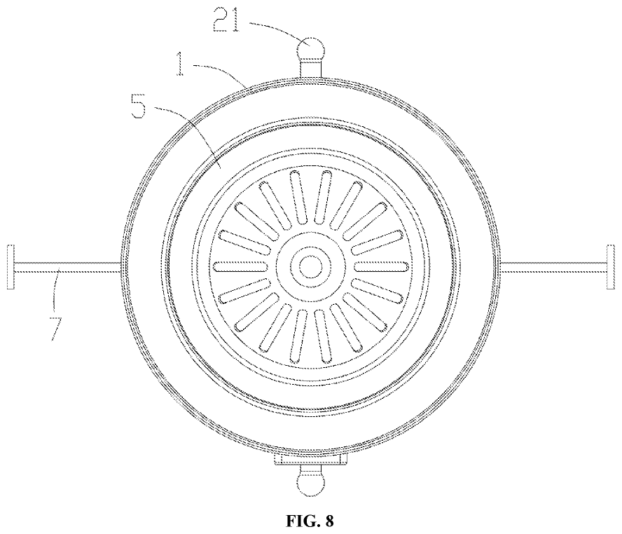

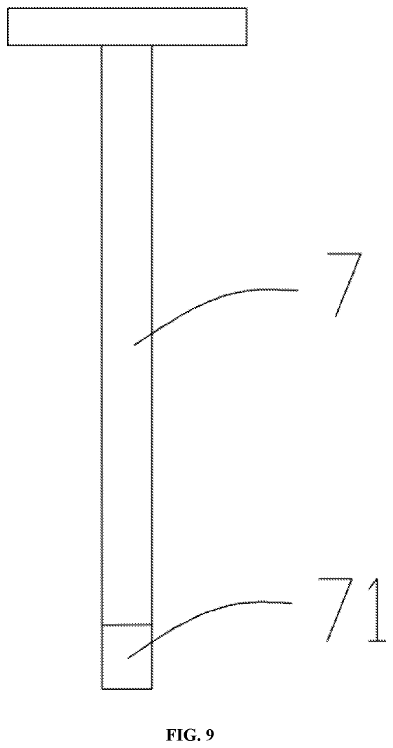

In an embodiment, referring to FIG. 8 and FIG. 9, the stove further includes handle portions 7 arranged on two sides of the outer barrel 1, so that it is convenient for a user to move the stove.

Specifically, in optimal implementation, the handle portions 7 are T-shaped in a top view. It should be understood that one end of each handle portion 7 is fixed on the outer barrel 1, and the other end of the handle portion 7 far away from the outer barrel 1 is grasped by a user. Thus, during use of this embodiment, a temperature of the end of the handle portion 7 far away from the outer barrel 1 is low, so that the user adjusts the position of the stove in use.

In an embodiment, the handle portions 7 are detachably arranged on the outer barrel 1. Specifically, a second screw hole 115 is formed in the outer barrel 1. One end of each handle portion 7 is a second screw 71. The handle portions 7 are fixed to the outer barrel 1 through cooperation between second screw 71 and the second screw hole 115. Thus, if the stove needs to be transported, the handle portions 7 can be removed to facilitate the transportation.

In other embodiments, the handle portions 7 can also be ringlike, a groove, or the like.

In the above embodiment, the handle portions 7 are arranged at positions, close to the top, on side walls of the outer barrel 1 to facilitate taking the stove of this embodiment and to prevent the problem that the stove is tilted and inconvenient to move when the stove is taken through the handle portions 7.

It should be noted that all directional indications (such as up, down, left, right, front, back . . . ) in the embodiments of the present disclosure are only used to explain a relative positional relationship between components, motion situations, etc. at a certain specific attitude (as shown in the figures). If the specific attitude changes, the directional indication also correspondingly changes.

In addition, the descriptions of “first”, “second”, etc. in the present disclosure are only used for descriptive purposes, and cannot be understood as indicating or implying its relative importance or implicitly indicating the number of technical features indicated. Therefore, features defined by “first” and “second” can explicitly instruct or impliedly include at least one feature. In addition, “and/or” in the entire text includes three solutions. A and/or B is taken as an example, including technical solution A, technical solution B, and technical solutions that both A and B satisfy. In addition, the technical solutions between the various embodiments can be combined with each other, but it needs be based on what can be achieved by those of ordinary skill in the art. When the combination of the technical solutions is contradictory or cannot be achieved, it should be considered that such a combination of the technical solutions does not exist, and is not within the scope of protection claimed by the present disclosure.

The above descriptions are only preferred embodiments of the present disclosure, and are not intended to limit the patent scope of the present disclosure. Any equivalent structural transformation made by using the content of the specification and the drawings of the present disclosure under the invention idea of the present disclosure, directly or indirectly applied to other related technical fields, shall all be included in the scope of patent protection of the present disclosure.

What is claimed is:

1. A stove, comprising an adjustment member, an outer barrel, and an inner barrel arranged inside the outer barrel, wherein the inner barrel is spaced apart from the outer barrel and forms a middle cavity with the outer barrel;
a first air inlet hole communicated with the middle cavity is formed in a side wall of the outer barrel, and a second air inlet hole communicated with the middle cavity is formed in a side wall of the inner barrel; and
the adjustment member is configured to adjust a size of the first air inlet hole under the action of an external force, and/or to adjust a size of the second air inlet hole.

2. The stove according to claim 1, wherein the adjustment member comprises a baffle plate movably arranged at a position, located at the first air inlet hole, on the outer barrel, and a poke rod arranged on the baffle plate; and
the baffle plate moves when a poke rod is pushed by the external force to gradually cover or move away from the first air inlet hole.

3. The stove according to claim 2, wherein a quantity of the first air inlet hole is plural, and the baffle plate is provided with a plurality of third air inlet holes having a same size as that of each first air inlet hole.

4. The stove according to claim 3, wherein a distance between two adjacent first air inlet holes is greater than a length of each first air inlet hole.

5. The stove according to claim 2, wherein cross sections of both the outer barrel and the inner barrel are circular; the baffle plate is ringlike and located in the middle cavity; and one end of the poke rod is connected to the baffle plate after passing through the first air inlet hole.

6. The stove according to claim 5, wherein the baffle plate is provided with a first screw hole located between two adjacent third air inlet holes; one end of the poke rod is a first screw; and the poke rod is mounted on the baffle plate through cooperation between the first screw and the first screw holes.

7. The stove according to claim 1, wherein a fourth air inlet hole is formed in the side wall of the inner barrel, and the fourth air inlet hole is located between the first air inlet hole and the second air inlet hole.

8. The stove according to claim 7, wherein the fourth air inlet hole is a mesh hole; a top of the mesh hole is close to the first air inlet hole; and a bottom of the mesh hole is close to the second air inlet hole.

9. The stove according to claim 7, wherein a viewing window is arranged on the outer barrel; a transparent piece is arranged at the viewing window; and the viewing window corresponds to the fourth air inlet hole.

10. The stove according to claim 1, wherein a bottom of the outer barrel is provided with a supporting leg configured to support the stove.

11. The stove according to claim 10, wherein the supporting leg is integrally formed with the outer barrel.

12. The stove according to claim 5, wherein an inner side wall of the outer barrel is provided with a bottom plate located below the first air inlet hole, and a bottom surface of the baffle plate is in contact with an upper surface of the bottom plate.

13. The stove according to claim 12, wherein a bearing slot is formed at a position, close to a top, on the inner side wall of the outer barrel; a top of the inner barrel is connected with a top barrel body; the top barrel body is formed by protruding outwards from the inner barrel; the top barrel body is arranged in the bearing slot to separate a bottom surface of the inner barrel from the bottom plate of the outer barrel; and the second air inlet is located below the top barrel body.

14. The stove according to claim 1, wherein a middle portion of a bottom of the inner barrel is raised upwards to form a boss, and a plurality of fifth air inlet holes are formed in a side wall of the boss.

15. The stove according to claim 14, wherein the first air inlet hole is located between the bottom surface of the inner barrel and the bottom plate.

16. The stove according to claim 13, wherein the outer barrel comprises a first barrel body and a second barrel body; the second barrel body is located on an inner side of the first barrel body and abuts against the first barrel body;
the first air inlet hole is located on the first barrel body, and the middle cavity is formed by encircling the second barrel body, the baffle plate, the bottom plate, the inner barrel, and the top barrel body; both the first barrel body and the second barrel body are provided with viewing windows; the second barrel body is located above the baffle plate; the bearing slot is formed by cooperation between the first barrel body and the second barrel body; an annular bearing plate is arranged at a position, close to a bottom, on an inner side wall of the second barre body; and the bottom plate is arranged on the annular bearing plate.

17. The stove according to claim 1, wherein the stove further comprises handle portions arranged on two sides of the outer barrel.

18. The stove according to claim 17, wherein the handle portions are T-shaped in a top view.

19. The stove according to claim 17, wherein the handle portions are detachably arranged on the outer barrel.

20. The stove according to claim 19, wherein a second screw hole is formed in the outer barrel; one end of each handle portion is a second screw; and the handle portions are fixed to the outer barrel through cooperation between second screw and the second screw hole.
